(19) United States
(12) Patent Application Publication
(10) Pub. No.: US 2005/0234699 A1
(43) Pub. Date: Oct. 20, 2005

(54) Data processing system

(76) Inventors: John Morrison, County Cork (IE); David Power, County Cork (IE); James J. Kennedy, Waterford (IE); Keith Power, Waterford (IE)

Correspondence Address: JACOBSON HOLMAN PLLC, 400 SEVENTH STREET N.W., SUITE 600, WASHINGTON, DC, 20004, US

(21) Appl. No.: 11/143,431

(22) Filed: Jun. 3, 2005

Related U.S. Application Data
(63) Continuation of application No. PCT/IE03/00159, filed on Dec. 3, 2003.

(30) Foreign Application Priority Data
Dec. 4, 2002 (IE) IE2002/0943

(51) Int. Cl. G06F 9/455

(52) U.S. Cl. 703/23

(57) ABSTRACT

A system (1) transmits cargo booking requests to airline booking systems (A), and receives feedback from them. A server (2) of the system (1) has templates for each airline system (A), and a switch (3) generates signals emulating input device inputs to a dedicated terminal (B) for each airline system (A). These commands populate a request screen if the airline system (A) as displayed on the dedicated terminal (B). The system (1) also captures screens displayed on the dedicated terminals (B) and generates feedback for agents at agent systems (6). The airline systems (A) thus can continue to operate as if they were interfacing with only dedicated terminals, thereby providing excellent access control for security.

### FIELD OF THE INVENTION

The invention relates to data processing systems, particularly for interfacing with external systems such as airline systems for which access control is very important.

### PRIOR ART DISCUSSION

Referring to Fig. A, at present in the airline cargo booking industry each airline has a system A of their own particular configuration. Sales offices handle queries and bookings to the airline systems on behalf of customers. Because security of the airline systems A is of paramount importance, each sales office is allowed access to each airline system A using only one or more dedicated terminals B having either leased-line C direct access or virtual private network access. It is not permitted for the terminal B to host any other software. Typically, each sales office has a network of administration PCs D linked to an administration database E.

Thus, when a customer wishes to book cargo, the agent must access the administration database E for customer data, and must separately use a terminal B associated with the relevant airline to make the query. Often, the agent must subsequently access the database E to update the customer record with the booking data.

This arrangement, while providing good security for the airline systems, means that agent work is very time-consuming. Also, data entry duplication can lead to a greater chance of human error.

The invention addresses these problems.

### SUMMARY OF THE INVENTION

According to the invention, there is provided a data processing system for receiving user inputs for transaction requests, for routing the request to a transaction processing system, and for receiving transaction confirmations from the transaction processing system, wherein
the system is linked with a terminal which is dedicated to interfacing with the transaction processing system,
the system comprises an emulator for transmitting input requests in the form of dedicated terminal input device signals by-passing input devices of the dedicated terminal, and
the system comprises a capture circuit for capturing a screen shot of the dedicated terminal and a processor for generating a feedback user output accordingly.

Thus, the transaction processing system such as an airline reservation system “sees” requests as if they were manually keyed into a dedicated terminal of the type which may not be permitted to host any other software.

In one embodiment, the system comprises a function for generating a template for each transaction interfacing screen of the transaction processing system, and for transmitting input request signals to populate a screen on the dedicated terminal according to the template.

In one embodiment, the function generates a template by capturing a screen identifying each form entity for user input activity, and generating a record for each form entity.

In one embodiment, the function recognises a form entity leading to another screen, and proceeds to a generate a template for the next screen.

In another embodiment, the system comprises a plurality of agent systems, a server, and an emulator.

In one embodiment, each agent system generates transaction request data, records the data on an agent system database, and subsequently transmits the data to the server for processing.

In a further embodiment, the server downloads an application to the agent system for generating the data and uploading it to the server.

In one embodiment, the server manages a queue of transaction requests from the agent systems.

In one embodiment, the server manages one queue per transaction processing system.

In one embodiment, the system is connected to a plurality of dedicated terminals for a transaction processing system, and routes requests to a next available dedicated terminal.

In one embodiment, the emulator comprises a switching mechanism for routing requests to the correct dedicated terminal.

In one embodiment, the server automatically monitors transaction processing status of the dedicated terminals to determine when they become free for a fresh transaction request.

In one embodiment, the server determines dedicated terminal status by performing optical character recognition on dedicated terminal display screens

In one embodiment, the system captures a dedicated terminal screen shot and displays the screen shot for a user as confirmation of a transaction.

In one embodiment, the system captures a dedicated terminal screen shot, and parses data in the screen shot to determine meaning of the data and generates a next transaction processing event accordingly.

In a further embodiment, the system automatically generates a fresh transaction request if a failure notification has been transmitted by the transaction processing system.

In one embodiment, the system generates a user alert if a transaction request failure notification is received at a dedicated terminal.

In one embodiment, the system automatically generates a user notification if it is configured to send user notifications in response to transaction events.

In one embodiment, the system further comprises a router for routing transaction requests to a different system if it does not have a link with a dedicated terminal of a required transaction processing system.

In one embodiment, the agent systems generate a uniform user interface for transaction requests for all of a plurality of transaction processing systems.

### DETAILED DESCRIPTION OF THE INVENTION

### BRIEF DESCRIPTION OF THE DRAWINGS

The invention will be more clearly understood from the following description of some embodiments thereof, given by way of example only with reference to the accompanying drawings in which:—

FIG. 1 is a schematic representation of a data processing system of the invention for airline cargo bookings and customer account management;

FIG. 2 is a flow diagram illustrating one aspect of operation of the system.

### DESCRIPTION OF THE EMBODIMENTS

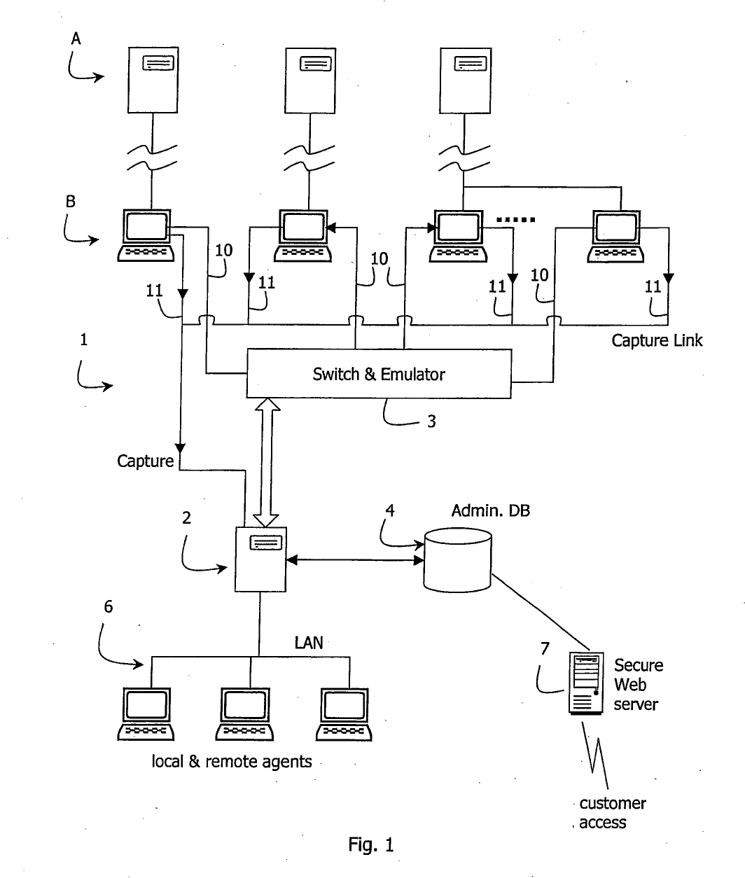

Referring to FIG. 1 a data processing system 1 performs both interfacing with external airline systems A and also cargo transaction processing and customer administration operations.

The system 1 accesses the airline systems A via conventional dedicated terminals B in a manner whereby the airline systems A interface in the same manner as for the prior art. Thus, use of the system 1 by a cargo reservations office is transparent to the airline systems A, however, productivity of the sales office is greatly improved without any impact on security of the airline systems A.

The system 1 comprises a central server 2 connected to a switch & emulator (“switch”) 3, in turn connected to the terminals B. The system 1 also comprises a number of agent workstations 6, both local and remote, linked with the server 2. The server 2 is also connected to an administration database 4. This records details of all sessions for subsequent use. A Web server 7 allows remote customer access to the database 4.

In more detail, cables 10 connect ports of the switch 3 to keyboard and mouse ports of the dedicated terminals B. The switch 3 saves a configuration of associations between its ports and terminals B, and also associations between terminals B and airline systems. The switch 3 comprises an emulation device for emulating each of the keyboard and mouse of each terminal B.

For routing inputs to a terminal B, the server generates the sequence of input actions such as character key depressions, tab key depressions, or mouse clicks. The switch 3 automatically generates the series of signals corresponding to each input action. For example, the input action of pressing the character key “A” actually results in a series of low-level signals being transmitted to the processor, such as interrupts and signals to indicate that a key has been depressed. Thus when the server generates an input for a particular dedicated terminal B it transmits a series of input action commands and an identifier of the destination airline system A. In response, the switch 3 automatically converts the commands into the appropriate terminal B input port signals and routes them to the relevant terminal B. A set out in more detail below, multiple sessions can be concurrently active with the switch managing a queue per airline system.

Screen captures from the terminals B are performed directly by the server 2 via the links 11.

The local and remote agent systems 6 present an interface form of a universal agent format for all query inputs by agents. The server 2 parses the inputted data in the universal agent form structure automatically using a template for each airline system A. It also generates a query for the administration database 4, and validates security requirements. Using the templates, the server 2 generates a query as a series of input actions for the relevant airline system A and transmits the query with a terminal B identifier to the switch 3.

As stated above, the server 2 also captures screens of the terminals B. It processes captured screens using optical character recognition (OCR) functions and generates outputs for the agents 6. The server 2 receives visual feedback from the terminals B and uses the template for the relevant airline system to determine on which region of the image to perform OCR. The data retrieved from these regions is reported to the relevant agent system 6 and is recorded in the database 4. The data can also be used to trigger other processes.

It will be noted that the templates are used to both route data to the terminals B with input device emulation and to process captured displays on the terminals B.

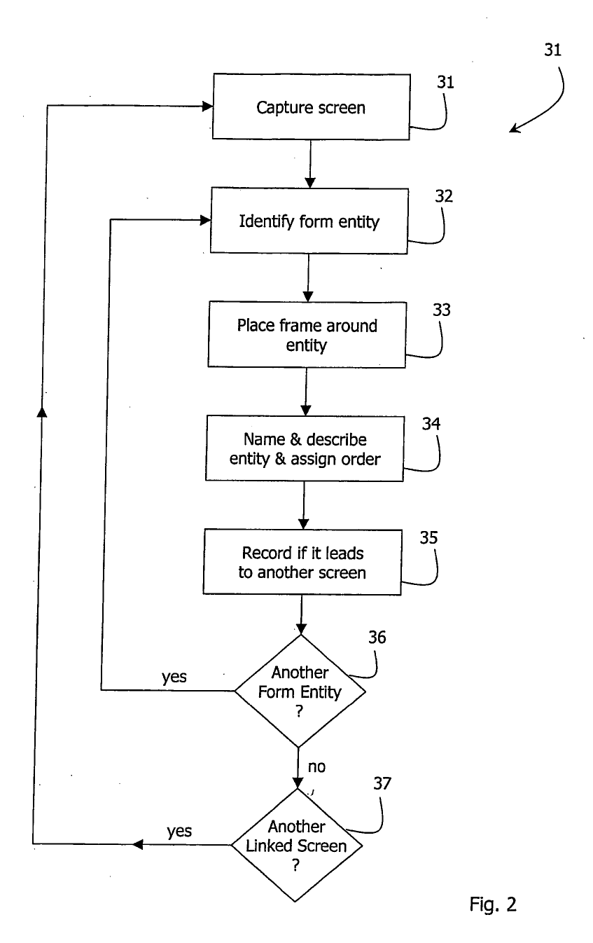

Referring to FIG. 2 the server 2 implements a method 30 to generate templates for each airline system A. The steps are:
31: Take a screen shot in step 31 of a first screen of an airline system A, as displayed on its associated terminal B. A “form entity” is any GUI item at which a user input may be made, such as a radio button or a text field.
32,33: A frame is placed around each form entity of the screen shot, the form entities being for example text fields, radio buttons, drop-down lists, and buttons.
34: Each form entity is named and described, and a sequential order is assigned to it. This is performed interactively with input from a supervisor. The descriptions depend on the form entity functions, having regard to whether an entity enables or disables other entities or leads to another screen.
36,37: A record is made if the entity leads to another screen. The above steps are repeated for each entity of each screen which is accessible from the first screen using named user navigation commands. Access to subsequent screens is achieved by transmitting an emulated input at the relevant form entity.

Construction of the system 1 is best described in more detail by way of use case Scenarios. These scenarios describe both different aspects of operation of the system 1, and also different systems, configured according to the commercial requirements such as number of airline systems to be interfaced with number of agents.

Scenario 1: One Agent System 6, One Terminal B

(a) The agent takes a telephone call and types a comment into the agent system 6.
(b) The agent system 6 generates an output file in a local database of the agent.
(c) Some time later, the agent instructs processing of the file. In response to such an instruction, a helper application residing on the agent system 6 routes the file to the server 2.
(d) The server 2 parses the file and generates input actions as a query for the terminal B. These input actions are generated according to the template for the airline system A. The switch 3 transmits the input actions in the form of a series of low-level emulated keyboard and mouse input signals. Thus, the airline system A “sees” data being inputted in its GUI as if it were manually keyed at the terminal B.
   Scenario 2: Multiple Agents Systems 6 and One Airline System A

In this scenario, three agents take cargo reservations and key them into their respective agent system 6. As for Scenario 1, each system 6 records a file F in its local database. This file is in an industry-standard word processing format. The helper application subsequently transmits the file F to the server 3.

The server 2 manages a queue. As each file is pulled from the queue, the server 2 uses the template to produce the correct input actions to populate the airline's GUI form. These keystrokes are transmitted to the switch 3 which emulates the keyboard and mouse of the terminal B. The server 2 also transmits notifications to the agent systems 6 to inform the agents when bookings are made. This is achieved by OCR of the data in the screens of the terminals B.

Scenario 3: One Agents, Many Airline Systems A

As for the above scenarios, the agent system 6 records a file of reservation data, which file is subsequently uploaded to the server 2. The server 2 sends a control string to the switch 3 to direct routing of data. The server 2 selects a template for the current airline system A and uses it to generate, with the switch 3, the series of keystrokes to fill the airline system's GUI form. The switch 3 both routes the keystrokes to the relevant terminal B, and performs the appropriate keyboard emulation. Where there are multiple airline systems the server 2 manages a queue for each airline, each incoming agent system 6 file being added to the relevant queue on a last-in-last-out basis. Where there are multiple terminals B for an airline system A, the server monitors status of each terminal B. It does this be performing OCR on captured screens to determine completion of a session, thus flagging the terminal B as being free for a next session.

Scenario 4: Many Airline Systems A, Many Agent Systems 6

The switch 3 in this embodiment has multiple COM parts, each connected to a terminal B.

As above, each agent system 6 generates a reservation file, which is transmitted to the server 2. The server 2 stores n templates, one for each of n airline system A. For each airline system A there may be multiple terminals B. As files are taken from the each queue they are transmitted to the next available terminal B for that airline system.

The above scenarios describe routing of reservation data to the airline systems A. In general, a file is generated locally at an agent system 6 and is routed to the server 2. This manages one queue per airline system A, if there is more than one. It uses a template associated with each airline system A to convert the data to a series of input actions to populate that form. The input actions are routed to the next available terminal B for that airline system A, with automatic conversion for emulation of the particular keyboard or mouse. The templates may be dynamically generated at frequent periods to ensure that any modifications to airline systems are accounted for.

Regarding routing of data from the terminals B to the server 2, the server 2 captures a screenshot as a reservation is being made. In a simple mode of operation the server 2 simply routes the screen shot to the agent system 6 as a bitmap for viewing as a confirmation of the reservation. This bitmaps may be save to the locally-stored file in the local agent database or in the database 5 of the server 2.

In another mode, the server 2 automatically parses the screenshot according to the relevant template. This parsing generates characters, which are recognised using optical character recognition (OCR). This data can be used by the server 2 to perform actions such as:
re-submit a previously failed booking,
generate an agent alert if the booking attempt is invalid,
update the database 5 if the booking is successful.

If a screen of a dedicated terminal B “locks”, the server automatically generates an appropriate series of input actions to attempt to free it.

The server 2 also includes a function for routing data to a server of a remote reservation system if it does not have direct access to the required terminal B. In this case the remote server routes data bi-directionally to the requesting server instead of to its local agent systems.

The server 2 also allows, via the Web server 6, direct reservation requests from customers as well as from agents (local or remote). This allows excellent versatility while still maintaining excellent access control for security of the airline systems A. The invention opens up the possibility of a wide range of user or agent systems being used for requesting transactions without risking security of the airline systems A. The link between the switch 3 and the terminals B is effectively a very secure firewall, as it allows flow of only dedicated terminal B input device emulation signals.

It will be appreciated that the invention allows agents to control customer administration and accesses to the airline systems without the need to double-enter data. Also, the potential for errors is greatly reduced. Furthermore, it will be appreciated that even if the terminals B are changed in technology, the system 1 will still provide the above advantages with little modifications.

The invention is not limited to the embodiments described but may be varied in construction and detail.

1. A data processing system for receiving user inputs for transaction requests, for routing the request to a transaction processing system, and for receiving transaction confirmations from the transaction processing system, wherein
the system is linked with a terminal which is dedicated to interfacing with the transaction processing system,
the system comprises an emulator for transmitting input requests in the form of dedicated terminal input device signals by-passing input devices of the-dedicated terminal, and
the system comprises a capture circuit for capturing a screen shot of the dedicated terminal and a processor for generating a feedback user output accordingly.

2. A data processing system as claimed in claim 1, wherein the system comprises a function for generating a template for each transaction interfacing screen of the transaction processing system, and for transmitting input request signals to populate a screen on the dedicated terminal according to the template.

3. A data processing system as claimed in claim 1, wherein the system comprises a function for generating a template for each transaction interfacing screen of the transaction processing system, and for transmitting input request signals to populate a screen on the dedicated terminal according to the template; and wherein the function generates a template by capturing a screen identifying each form entity for user input activity, and generating a record for each form entity.

4. A data processing system as claimed in claim 1, wherein the system comprises a function for generating a template for each transaction interfacing screen of the transaction processing system, and for transmitting input request signals to populate a screen on the dedicated terminal according to the template; and wherein the function generates a template by capturing a screen identifying each form entity for user input activity, and generating a record for each form entity; and wherein the function recognises a form entity leading to another screen, and proceeds to a generate a template for the next screen.

5. A data processing system as claimed in claim 1, wherein the system comprises a plurality of agent systems, a server, and an emulator.

6. A data processing system as claimed in claim 1, wherein the system comprises a plurality of agent systems, a server, and an emulator; and wherein each agent system generates transaction request data, records the data on an agent system database, and subsequently transmits the data to the server for processing.

7. A data processing system as claimed in claim 1, wherein the system comprises a plurality of agent systems, a server, and an emulator; and wherein each agent system generates transaction request data, records the data on an agent system database, and subsequently transmits the data to the server for processing; and wherein the server downloads an application to the agent system for generating the data and uploading it to the server.

8. A data processing system as claimed in claim 1, wherein the system comprises a plurality of agent systems, a server, and an emulator; and wherein the server manages a queue of transaction requests from the agent systems.

9. A data processing system as claimed in claim 1, wherein the system comprises a plurality of agent systems, a server, and an emulator; and wherein the server manages a queue of transaction requests from the agent systems; and wherein the server manages one queue per transaction processing system.

10. A data processing system as claimed in claim 1, wherein the system comprises a plurality of agent systems, a server, and an emulator; and wherein the server manages a queue of transaction requests from the agent systems; and wherein the server manages one queue per transaction processing system; and wherein the system is connected to a plurality of dedicated terminals for a transaction processing system, and routes requests to a next available dedicated terminal.

11. A data processing system as claimed in claim 1, wherein the system comprises a plurality of agent systems, a server, and an emulator; and wherein the server manages a queue of transaction requests from the agent systems; and wherein the server manages one queue per transaction processing system; and wherein the emulator comprises a switching mechanism for routing requests to the correct dedicated terminal.

12. A data processing system as claimed in claim 1, wherein the system comprises a plurality of agent systems, a server, and an emulator; and wherein the server manages a queue of transaction requests from the agent systems; and wherein the server manages one queue per transaction processing system; and wherein the server automatically monitors transaction processing status of the dedicated terminals to determine when they become free for a fresh transaction request.

13. A data processing system as claimed in claim 1, wherein the system comprises a plurality of agent systems, a server, and an emulator; and wherein the server manages a queue of transaction requests from the agent systems; and wherein the server manages one queue per transaction processing system; and wherein the server automatically monitors transaction processing status of the dedicated terminals to determine when they become free for a fresh transaction request; and wherein the server determines dedicated terminal status by performing optical character recognition on dedicated terminal display screens

14. A data processing system as claimed in claim 1, wherein the system captures a dedicated terminal screen shot and displays the screen shot for a user as confirmation of a transaction.

15. A data processing system as claimed in claim 1, wherein the system captures a dedicated terminal screen shot, and parses data in the screen shot to determine meaning of the data and generates a next transaction processing event accordingly.

16. A data processing system as claimed in claim 1, wherein the system captures a dedicated terminal screen shot, and parses data in the screen shot to determine meaning of the data and generates a next transaction processing event accordingly; and wherein the system automatically generates a fresh transaction request if a failure notification has been transmitted by the transaction processing system.

17. A data processing system as claimed in claim 1, wherein the system captures a dedicated terminal screen shot, and parses data in the screen shot to determine meaning of the data and generates a next transaction processing event accordingly; and wherein the system generates a user alert if a transaction request failure notification is received at a dedicated terminal.

18. A data processing system as claimed in claim 1, wherein the system captures a dedicated terminal screen shot, and parses data in the screen shot to determine meaning of the data and generates a next transaction processing event accordingly; and wherein the system automatically generates a user notification if it is configured to send user notifications in response to transaction events.

19. A data processing system as claimed in claim 1, wherein the system further comprises a router for routing transaction requests to a different system if it does not have a link with a dedicated terminal of a required transaction processing system.

20. A data processing system as claimed in claim 1, wherein the system comprises a plurality of agent systems, a server, and an emulator; and wherein the agent systems generate a uniform user interface for transaction requests for all of a plurality of transaction processing systems.
